(19) United States
(12) Patent Application Publication
(10) Pub. No.: US 2019/0389477 A1
(43) Pub. Date: Dec. 26, 2019

(54) METHOD OF CONTROLLING AN INTERNAL COMBUSTION ENGINE OF A VEHICLE, AND A CONTROL SYSTEM FOR SUCH AN INTERNAL COMBUSTION ENGINE

(71) Applicant: TRW AUTOMOTIVE ELECTRONICS & COMPONENTS GMBH, Radolfzell (DE)

(72) Inventors: Karthik Balakrishna, Novi, MI (US); Kevin Kurth, Commerce Township, MI (US); Frank Hertwig, Brighton, MI (US)

(21) Appl. No.: 16/017,216

(22) Filed: Jun. 25, 2018

(51) Int. Cl. B60W 50/00; B60W 40/08; F02N 11/08

(52) U.S. Cl. CPC B60W 50/0098; B60W 40/08; F02N 11/0807; B60W 2710/06; B60W 2040/0881; B60W 2510/06; F02N 11/0811

(57) ABSTRACT

A method of controlling an internal combustion engine of a vehicle comprises the following steps:
on determining that the engine is running, determining whether or not the engine was started using a remote start procedure;
   if the engine is determined to have been started using the remote start procedure, starting a timer to run for a predetermined period;
      determining whether a door of the driver compartment has been opened or closed after the determining that the engine is running; if it is determined that a door has been opened, determining whether a transmission of the vehicle has been engaged;
      if the transmission has not been engaged, turning off the engine on expiry of the period;
      if the transmission has been engaged, terminating the method;
   if the engine is determined not to have been started using the remote start procedure, performing a check to establish whether a driver compartment of the vehicle has any occupants;
   starting a timer to run for a predetermined period if the check reveals that there are no occupants in the driver compartment of the vehicle;
   resetting the timer in the event that an occupant is detected in the driver compartment of the vehicle before expiry of the period, otherwise
turning off the engine on expiry of the period.

### TECHNICAL FIELD

The present invention relates to a method of controlling an internal combustion engine of a vehicle, a control system for an internal combustion engine of a motor vehicle, and a motor vehicle including such a control system.

### BACKGROUND

The internal combustion engine and vehicles powered by internal combustion engine have given mankind enormous benefits since their invention in the nineteenth century. Unfortunately, the running of internal combustion engines may also produce carbon monoxide, which is poisonous to humans and other animals in sufficiently high doses. Carbon monoxide is colorless and odorless, and the initial symptoms of its poisoning are easy to dismiss as routine ailments.

In 2011, the CDC-Center for Disease Control and Prevention stated in their weekly report that carbon monoxide poisoning is a leading cause of unintentional poisoning deaths in the United States. Over the period 1999-2010, there were 5,149 deaths from unintentional carbon monoxide poisoning in the US—an average of 429 each year. Carbon monoxide poisoning is also responsible for approximately 15,000 emergency department visits in the United States each year.

Carbon monoxide binds to the hemoglobin in blood to form carboxyhemoglobin which is less effective in delivering oxygen to tissue. Even if non-fatal, carbon monoxide poisoning is a particular concern for pregnant women. This is not only because the fetus receives less oxygen from the mother's blood, but also because carbon monoxide crosses the placenta, and the blood of the fetus has an even greater affinity for carbon monoxide than does adult blood. Tragically, this means that if a pregnant woman is exposed to a high dose of carbon monoxide, her baby may die even though the mother's health is ultimately unaffected.

One of the common causes of unintentional carbon monoxide poisoning is carbon monoxide emitted in the exhaust fumes of motor vehicle internal combustion engines, and incidents typically occur when a motor vehicle engine is left running while the vehicle is in an enclosed space such as a parking garage.

In the home environment it is generally recommended that a carbon monoxide detector be placed in each bedroom, and also in spaces where fuel, whether gas or solid, is combusted inside the house—for example where appliances such as cookers, boilers, and fires are located. Because of the risk of exhaust fumes, it is also recommended to fit carbon monoxide detectors in garages and other enclosed parking spaces, especially if these are integral with, or adjacent to, living accommodation.

Unfortunately, despite the life-saving potential of carbon monoxide detectors, many home owners and occupants neglect to fit them—just as they often neglect to fit similarly beneficial smoke detectors. While this is understandable, it does mean that many lives tragically continue to be lost needlessly.

Over recent years, motor manufacturers have been very successful in reducing the level of sound produced by motor vehicles—so that for many motor vehicles it may be difficult to hear any sound from an engine that is idling. This has made it even easier to leave the engine of a vehicle running inadvertently.

This problem is exacerbated by the trend for vehicles to be fitted with so-called keyless ignition systems. With these systems it is no longer necessary to insert an ignition key into a slot inside the vehicle to enable the vehicle to be started. Instead, the key may be replaced with a “fob” or “button” which communicates wirelessly with a system in the vehicle. The key fob, fob, or button may also considered to be a remote control or remote controller. Provided the fob or, more generally, remote controller is within range of the vehicle (perhaps within 20 to 50 feet) the vehicle can be started simply by pressing a button inside the vehicle. But in many cases it is even possible to start the vehicle remotely, that is without even opening a door of the vehicle—using what is known as “remote start” or a remote start procedure. This has proved to be a very attractive feature for vehicle owners who live in regions where winter temperatures fall low enough for ice and snow to form. The feature enables the vehicle owner to start their car or truck from the comfort of their home, so that when setting off on a journey the vehicle's engine and interior are both up to temperature, and the windshields clear or ice and snow. But this convenience does risk the engines of vehicles being started or left running, inadvertently, with possibly tragic consequences.

### SUMMARY OF THE INVENTION

According to a first aspect, the present invention provides a control system for an internal combustion engine of a motor vehicle having a driver compartment,

the control system comprising:

an occupant detection module coupled to one or more occupant detection sensors configured to detect the presence of one or more occupants in a driver compartment of the vehicle;

an engine management module coupled to one or more engine status sensors configured to determine whether the engine is running;

one or more door status sensors configured to determine whether a door of the driver compartment is in an open condition or in a closed condition;

the control system being configured, on the engine management module determining that the engine is running, to determine whether or not the engine was started using a remote start procedure;
if the engine is determined to have been started using the remote start procedure, to start a timer to run for a predetermined period;
   to determine whether a door of the driver compartment has been opened or closed after the determining that the engine is running; if it is determined that a door has been opened, to determine whether a transmission of the vehicle has been engaged;
   if the transmission has not been engaged, to turn off the engine on expiry of the period;
if the engine is determined not to have been started using the remote start procedure, to perform a check to establish whether the driver compartment of the vehicle has any occupants;
to start a timer to run for a predetermined period if the check reveals that there are no occupants in the driver compartment of the vehicle;
to reset the timer in the event that an occupant is detected in the driver compartment of the vehicle before expiry of the period, otherwise to turn off the engine on expiry of the period.

In a second aspect, the present invention provides a method of controlling an internal combustion engine of a vehicle, the method comprising:

on determining that the engine is running, determining whether or not the engine was started using a remote start procedure;
if the engine is determined to have been started using the remote start procedure, starting a timer to run for a predetermined period;
   determining whether a door of the driver compartment has been opened or closed after the determining that the engine is running; if it is determined that a door has been opened, determining whether a transmission of the vehicle has been engaged;
   if the transmission has not been engaged, turning off the engine on expiry of the period;
   if the transmission has been engaged, terminating the method;
if the engine is determined not to have been started using the remote start procedure, performing a check to establish whether a driver compartment of the vehicle has any occupants;
starting a timer to run for a predetermined period if the check reveals that there are no occupants in the driver compartment of the vehicle;
resetting the timer in the event that an occupant is detected in the driver compartment of the vehicle before expiry of the period, otherwise turning off the engine on expiry of the period.

Optionally, in the event that the timer is started following a determination that the engine was not started using the remote start procedure, the method further includes transmitting a signal to cause a key fob of the vehicle to vibrate. This enables the operator of the vehicle to be reminded, remotely, of the fact that she has left the engine of her vehicle running. The fob may be arranged to vibrate continuously or intermittently throughout the period.

Optionally, prior to transmitting the signal to the key fob, the method may include determining whether the key fob is located within the vehicle, and in the event that the key fob is determined to be within the vehicle not transmitting the signal to cause the key fob to vibrate. In this way, battery life of the fob is saved in situations when the fob is not actually with the operator.

A method of the invention may further comprise, on turning off the engine on expiry of the period, transmitting a second signal to cause the key fob to cease to vibrate. In this way, if the fob has been vibrating since being notified, further vibration can be prevented, thereby saving the battery of the fob.

Optionally, if the engine is determined to have been started using the remote start procedure, the method may include resetting the timer once before expiry of the period in the event that it is determined that a door has been opened and the transmission has not been engaged. In this way, knowledge of door opening enables the controller to determine that the operator has come to the vehicle after having started it remotely, and the engine is not shut down initially because the operator may be making pre-journey adjustments to the vehicle—such as setting a destination in a satellite navigation system, making a call to announce their ETA, or loading the vehicle.

Optionally, if the engine is determined not to have been started using the remote start procedure, a method of the invention may include, subsequent to performing the check to establish whether the driver compartment has any occupants, determining whether a door of the driver compartment has been opened or closed after the determining that the engine is running, and if a door is determined to have been opened or closed, resetting the period of the timer. In this way, an operator is given time to go and fetch things from the house, or to say their pre-journey farewells, without the engine being shut down. Often, particularly in colder climates, drivers like to let the drivers cabin come up to temperature, let windscreens clear, and vehicle heating systems often take up to 10 minutes to get up to temperature. This aspect of a method of the invention takes these considerations into account and provides a better experience for the user.

According to a third aspect, the present invention provides a motor vehicle having an internal combustion engine and a driver compartment, the motor vehicle comprising:

a controller to operate a control system for the internal combustion engine;

one or more occupant detection sensors coupled to the controller and configured to detect the presence of one or more occupants in the driver compartment of the vehicle;

one or more engine status sensors coupled to the controller and configured to determine whether the engine is running;

one or more door status sensors configured to determine whether a door of the driver compartment is in an open condition or in a closed condition;

the control system being configured, on the one or more engine status sensors determining that the engine is running,

to determine whether or not the engine was started using a remote start procedure;
if the engine is determined to have been started using the remote start procedure, to start a timer to run for a predetermined period;
   to use the one or more door status sensors to determine whether a door of the driver compartment has been opened or closed after the determining that the engine is running; if it is determined that a door has been opened, to determine whether a transmission of the vehicle has been engaged;
   if the transmission has not been engaged, to turn off the engine on expiry of the period;
if the engine is determined not to have been started using the remote start procedure, to use the one or more occupant detection sensors to perform a check to establish whether the driver compartment of the vehicle has any occupants;
to start a timer to run for a predetermined period if the check reveals that there are no occupants in the driver compartment of the vehicle;
to reset the timer in the event that an occupant is detected in the driver compartment of the vehicle before expiry of the period, otherwise to turn off the engine on expiry of the period.

### BRIEF DESCRIPTION OF THE DRAWINGS

Preferred embodiments of the invention will now be described, by way of example only, with reference to the accompanying drawings, in which:

FIG. 1 is a schematic perspective view of a motor vehicle having an internal combustion engine fitted with a control system according to a first aspect of the invention;

FIG. 2 is a schematic part sectional, plan view of the motor vehicle of FIG. 1,

FIG. 3 is a schematic diagram showing an arrangement of sensors and their connections to a processor of a control system according to an embodiment of the invention; and

FIG. 4 is a flow chart for a method of controlling an internal combustion engine according to an embodiment of the invention.

### DETAILED DESCRIPTION

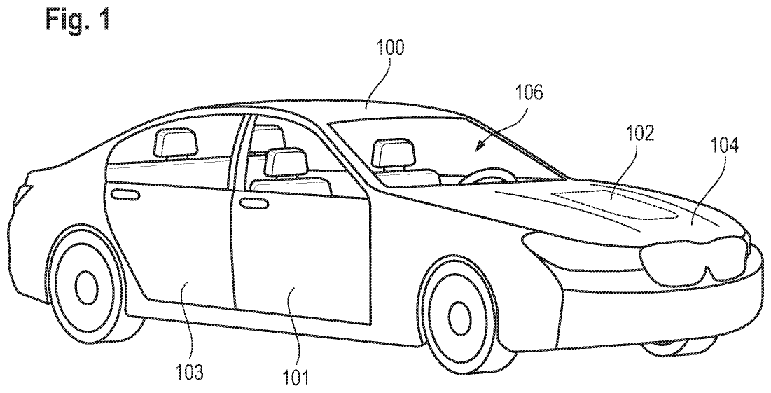

FIG. 1 is a schematic perspective view of a motor vehicle 100 having an internal combustion engine 102 fitted with a control system according to a first aspect of the invention. In this example the motor vehicle 100 is a four-door sedan, with two front doors 101, and two rear doors 103. A gasoline engine 102 is fitted in an engine compartment 104 at the front of the vehicle.

In this particular vehicle there is a single compartment 106 for occupants of the vehicle, which a driver shares with any passengers. This compartment may be referred to as a passenger compartment or as a driver compartment, and the two terms are interchangeable in this specification unless the context clearly requires otherwise. In this driver compartment there are separate seats 108, 108′ in the front of the compartment for the driver and for one passenger. In the rear of the compartment, there is a bench seat 110, to accommodate three passengers side by side in sitting places (seats) 110′, 110″, and 110″.

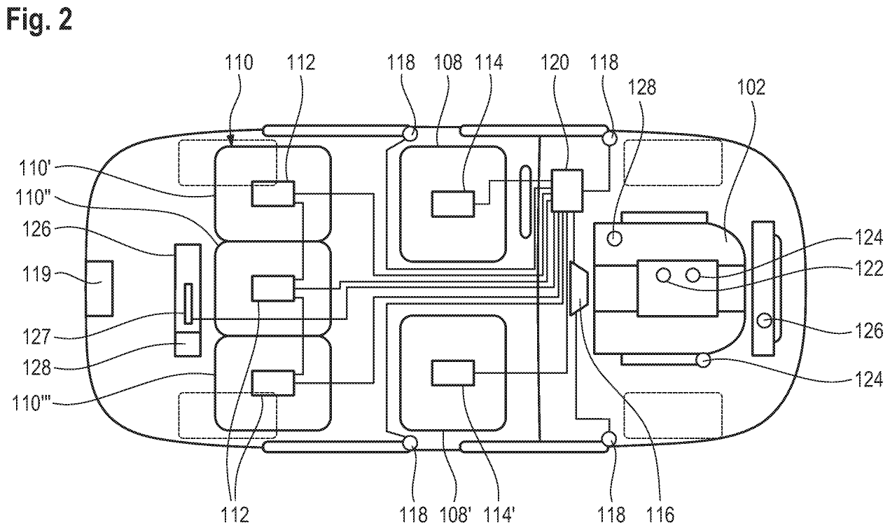

As shown in FIG. 2, the vehicle is fitted with one or more occupant detection systems. An occupant detection system may include a sensor associated with each seat or sitting place within a vehicle. So, for example, a load cell, micro switch, or other sensor is placed in association with each seat or sitting place to detect when that seat is occupied. In this example, the bench seat 110 in the rear of the compartment is designed to seat up to 3 passengers, so it has a sensing arrangement 112 that can detect whether or not there is a passenger for in any of the 3 seats (or sitting places on the bench seat). Similarly, in the front of the passenger compartment, the driver's seat 108 and the front passenger seat 108′ each has its own sensor 114, 114′ to detect whether the seat is occupied. For example, these seat sensors may be the sensors used by a seat-belt monitoring system to determine whether a particular seat is occupied and to provide a warning sign, audible, visual or both, when a particular seat is determined to be occupied but the associated seat belt is unused or improperly closed.

Additionally or alternatively, the occupant detection system may include one or more sensors, such as one or more visual light or infrared or far infrared cameras, or radar, lidar, leddar, or one or more ultrasound sensors, or any combination of the foregoing, to detect the presence of one or more occupants. Such systems may be provided as part of an airbag control system as a means to enable intelligent control of airbags and similar or alternative restraint systems, to ensure that only the correct airbags or other protective measures are deployed in the event of a collision or crash. Such systems may be used as an alternative to seat-based sensors of the type previously described, or in addition to them. In the example shown here, a lidar (light detecting and ranging) system is provided with at least one front detector 116 mounted on or in the dashboard or rear-view mirror assembly, and another 116′ provided to monitor the rear seats and located, for example in the roof or the passenger cabin—for example as part of a roof-mounted interior light assembly.

Also provided are sensors 118 for sensing the state of the doors 101, 103, of the passenger compartment. One sensor 118 is provided for each of the four doors of the passenger compartment, and may typically be provided for triggering one or more interior lights in the event that a door is detected as being opened, and for triggering the light to be turned off following closure of the last open door. The sensors may also be used in conjunction with a warning system that, for example displays lights or signs in the dashboard, and/or provides an audible warning tone or message, in the event that a door is detected as being in an open state when the ignition is on or when the engine is running. Additionally, the vehicle may be provided with one or more sensors (119) to detect the opening and closing of the trunk or tailgate, and that may also result in warning messages being provided visually or audibly under certain circumstances.

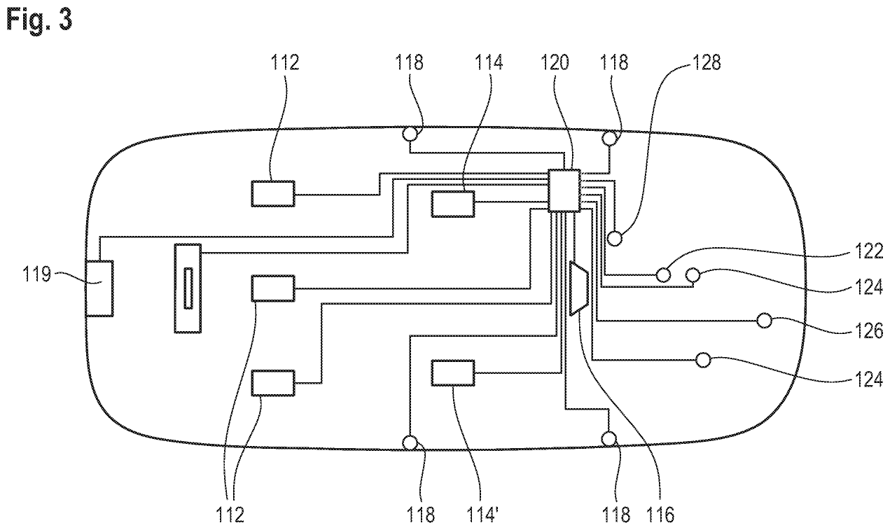

FIG. 2 also shows a controller 120 for managing and administering the various systems of the car, such as engine management, the anti-lock brake system, a traction control system, an electronic stability control system, the internal safety systems of the vehicle—such as airbags and seat belts, etc. This controller will be described in more detail later but includes one or more processors, long-term memory for storing software and program instructions to control and manage the various systems and to store data, and active memory for execution of programs and data handling. As shown more clearly in FIG. 3, each of the sensors, 112, 114, 116, of the occupant detection systems, and those 118 of the doors and trunk or tailgate, feeds its output signals and status to the controller 120, typically through wired connections. These wired connections may conveniently form part of a CAN bus of the vehicle. The controller is both able to receive signals from the various sensors and to interrogate the various sensors, for example to determine their individual status at any time.

The controller 120 is also connected to various sensors in or associated with the engine 102, and may administer an engine management systems. For example, the engine 102 has one or more sensors 122 that are part of a fuel injection system that monitor fuel delivery, throttle body opening, and air temperature, one or more sensors 124 that monitor one or more properties of exhaust gases produced by the engine, one or more sensors 126 that monitor coolant temperature, one or more sensors 128 that monitor engine oil and transmission oil temperature, etc. The controller 120 is also connected to various other sensors and systems in the driver compartment, such as a throttle position sensor, clutch position sensor, and a transmission position sensor that can determine the setting of the transmission, for example whether or not the transmission is in “park” or in a “drive” setting or, in the case of manual transmission, whether the transmission is in neutral or whether or not a gear is engaged. The controller is also connected to the ignition system of the car, and is responsible for receiving instructions to turn on or off the ignition and instructions to start the engine. These instructions may be received from controls within the passenger compartment, but some or all of these instructions may also be received from a remote control, for example from a key, key fob or fob of a remote keyless entry system (RKE). The remote control is in effect a hand held transmitter which may be part of a separate RKE fob, or part of a vehicle ignition key (a “keyhead” that may include a keyhead transponder for use in vehicle immobilization).

To this end, the vehicle includes a radio receiver 126, having at least one antenna 127 connected to the controller, to receive control instructions wirelessly from the key or key fob and to supply these to the controller.

The vehicle may also include a radio transmitter 128 that may be integral with the receiver 126 or separate, and that may be used to send signals to the key or key fob. For example, these signals may provide feedback in response to instructions received from the key or key fob. The key or key fob itself includes a processor, memory and battery, together with a transmitter, and optionally a receiver, and one or visual indicators to provide an output following receipt of messages from the controller of the car, and to provide feedback to user inputs. The key or key fob may also include a display for displaying words or pictograms, for example. The key or key fob may also include a loudspeaker or other element to provide audible signals, and likewise may include a haptic feedback element to provide a haptic signal—such as vibration or the like, on receipt of a signal from the controller.

The vehicle is also able to detect the presence of the key or key fob within the vehicle (in the passenger compartment, or optionally in the trunk or other load space). This can be achieved using a received signal strength detected by the receiver of the vehicle that is used to receive remote instructions from the key or key fob—such as remote unlocking or remote engine start instructions, but may alternatively be detected using an alternative method. For example, the key or key fob may communicate its presence to the vehicle using near field communication (NFC), LF or the key or fob may include an RFID tag that can only be read by a reader provided inside the driver compartment of the vehicle. The key or key fob may alternatively communicate its presence to the vehicle using Bluetooth, Bluetooth LE, or the like, or one of the frequencies allocated by the FCC to RKE and Passive Entry and Passive Start systems.

The RKE system of the vehicle may include antennas for each of the doors of the vehicle, as well as for the trunk or tailgate of the vehicle, as well as one or more antennas within the cabin of the vehicle, to enable the location of the RKE fob with respect to the vehicle to be determined to a high degree of precision.

The controller executes the instructions of one or more computer programs that are stored in a memory of the controller or some other tangible data carrier whose contents are accessible by the controller. Under the control of these instructions, the comptroller provides:

an occupant detection module coupled to one or more occupant detection sensors configured to detect the presence of one or more occupants in a passenger compartment of the vehicle;

an engine management module coupled to one or more engine status sensors configured to determine whether the engine is running; and optionally

a door status monitoring module coupled to one or more door status sensors each of which is associated with one of the at least one doors of the passenger compartment, the door status monitoring module being configured to capture door status changes sensed by a door status sensor when a door is opened and when a door is closed.

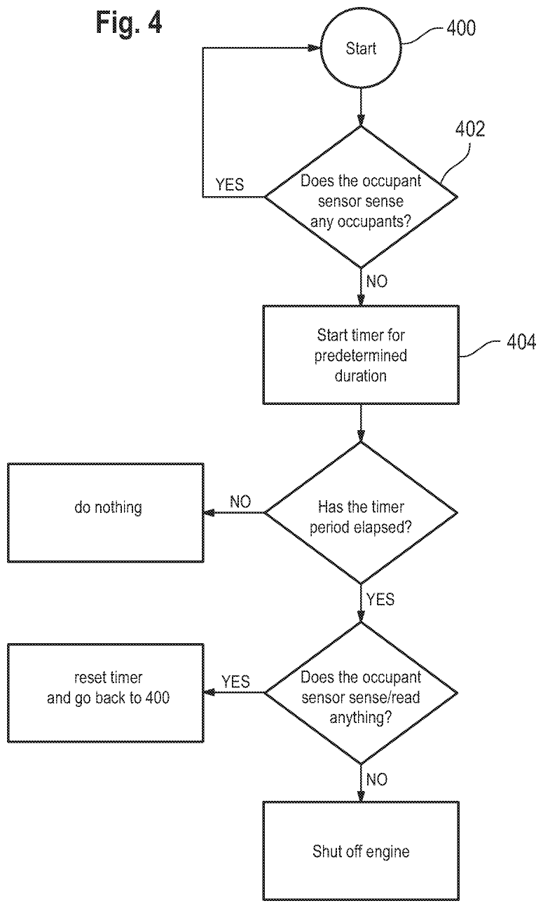

Turning now to FIG. 4, an example of the operation of a control system for an internal combustion engine of a motor vehicle according to an embodiment the present invention is represented by means of a flow chart. The operation begins on system wake up 400. The initial event, 401, is determination of engine status, that is whether the engine is running or not. This may involve detection by the controller of an engine start event. The controller 120 controls the engine management system, and therefore engine start events are monitored by the controller. This determination may show that the engine is not running, in which case, 402, the controller carries out no further steps. This status may equate to the ignition of the vehicle being turned on, but the engine not started. A subsequent act of starting the engine leads to another determination 401.

The next determination is of whether or not the vehicle's engine was started remotely 403. As noted above, the controller 120 controls the engine management system as well as receiving events and instructions from controls in the vehicle's cabin (e.g. a “start” button”) and from the RKE fob or remote control. Therefore, when an engine start event occurs, the controller is aware of the source of the instruction that initiated the start procedure.

If the engine was started not as the result of a remote start procedure, but for example by the activation of a start button or more generally a start action in the driver's compartment of the vehicle, the controller runs 411 the occupant detection module to check the occupant detection status as provided by the occupant detection sensors. If at least one occupant is detected, the controller may end the routine 412 because it can be assumed that the vehicle's running status has not been “forgotten” or overlooked. As an alternative, not shown, the controller may start a timer, with a period of for example 10 minutes. after which the occupant detection status is checked again. If one or more occupants are detected after the expiry of the period, the controller may cause an audible announcement within the vehicle, and optionally via the fob, to the effect that “The engine is running” and possibly giving a warning about a risk of carbon monoxide. This process of resetting the timer and checking occupancy may be repeated as many times as necessary, together with audible warnings or display warnings. A counter may be advanced with each iteration, so that warnings about the increasing risk from leaving the engine running may increase in severity between iterations. The controller may configured to shut down the engine after a certain number of iterations—for example restricting the engine running time to no more than 20 or 30 minutes. Any shut down may be accompanied by an announcement over an audio system of the vehicle or display warning messages on the dash board of the vehicle, and optionally via the fob, to the effect that the engine has been shut down for safety reasons (e.g. announcing the desire to reduce the risk of carbon monoxide poisoning or display the desire to reduce the risk of carbon monoxide poisoning).

Alternatively, if no occupant is detected at 411, the controller 120 starts 413 a timer to run for a predetermined period. This period may be in the range of 5 to 15 minutes, for example 10 or 12 minutes. Additionally, the controller may be arranged to determine whether the fob is within the vehicle or not. If the fob is determined not to be within the vehicle, the controller 120 may cause a signal to be transmitted wirelessly to the fob to instruct it to vibrate—using a haptic element in the fob, or the fob's loudspeaker, to cause the fob to vibrate in a noticeable way. In this way, the operator of the vehicle, or the holder of the fob may feel, hear, or see that the fob is vibrating—and be reminded that the engine of the vehicle is running. The vibration of the fob may be designed to produce an audible warning—which may be a tone or alarm, but may alternatively or additionally be a voiced message—e.g. “Warning, you have left the engine of your vehicle running!”.

During the predetermined period for which the timer runs, a door status check 414 is performed to reveal whether any door of the vehicle has been opened or closed. This check may include a check of the trunk or tailgate of the vehicle.

If no door opening or closing events are detected before the expiry of the period, the controller is arranged 415 to shut down the engine. If the controller had instructed the fob to vibrate, the controller sends a further instruction to the fob to cause it to stop vibrating, in order to avoid running down the battery of the fob. The further instruction may include an element that causes the fob to announce the fact that the engine of the vehicle has been shut down.

If a door opening or closing event is detected, signifying that someone is interacting with the vehicle and that therefore it has clearly not been forgotten, the controller resets the period of the timer to run again. The period may be reset to the same duration as before, or to a shorter or longer period. A duration of 10 minutes may be convenient. At the expiry of the reset period, 417, the controller is arranged to shut down the engine. If the controller had instructed the fob to vibrate, the controller sends a further instruction to the fob to cause it to stop vibrating, in order to avoid running down the battery of the fob. The further instruction may include an element that causes the fob to announce the fact that the engine of the vehicle has been shut down. The process then terminates at 418.

Alternatively, if the vehicle was started as the result of a remote start instruction, the controller 120 starts a timer 404 to run for a predetermined period. This period may be in the range of 5 to 15 minutes, for example 10 or 12 minutes.

During the predetermined period for which the timer runs, a door status check 405 is performed to reveal whether any door of the vehicle has been opened or closed. This check may include a check of the trunk or tailgate of the vehicle.

If no door opening or closing events are detected before the expiry of the period, the controller is arranged 406 to shut down the engine. If the controller had instructed the fob to vibrate, the controller sends a further instruction to the fob to cause it to stop vibrating, in order to avoid running down the battery of the fob. The further instruction may include an element that causes the fob to announce the fact that the engine of the vehicle has been shut down.

If a door opening or closing event is detected, the controller 120 checks, using a transmission sensor, to determine 407 whether or not the transmission has been engaged—for example whether an auto transmission has been moved from Park or Neutral, for example moved into Drive or Reverse, or whether a manual transmission has been moved out of neutral and into gear.

If it is determined that the transmission has been engaged, the process terminates at 408. If it is determined that, following detection of a door opening or closing event, the transmission has not been engaged, the timer is reset 409. The period may be reset to the same duration as before, or to a shorter or longer period. A duration of 10 minutes may be convenient. At the expiry of the reset period, 410, the controller is arranged to shut down the engine. The controller may be configured to transmit a signal to the fob causing it to announce the shutting down of the engine—orally, visually, or through another sound or vibration.

What is claimed is:

1. A method of controlling an internal combustion engine of a vehicle, the method comprising:
on determining that the engine is running, determining whether or not the engine was started using a remote start procedure;
if the engine is determined to have been started using the remote start procedure, starting a timer to run for a predetermined period;
determining whether a door of the driver compartment has been opened or closed after the determining that the engine is running; if it is determined that a door has been opened, determining whether a transmission of the vehicle has been engaged;
if the transmission has not been engaged, turning off the engine on expiry of the period;
if the transmission has been engaged, terminating the method;
if the engine is determined not to have been started using the remote start procedure, performing a check to establish whether a driver compartment of the vehicle has any occupants;
starting a timer to run for a predetermined period if the check reveals that there are no occupants in the driver compartment of the vehicle;
resetting the timer in the event that an occupant is detected in the driver compartment of the vehicle before expiry of the period, otherwise turning off the engine on expiry of the period.

2. A method as claimed in claim 1, wherein in the event that the timer is started following a determination that the engine was not started using the remote start procedure, transmitting a signal to cause a key fob of the vehicle to vibrate.

3. A method as claimed in claim 2, further comprising, on turning off the engine on expiry of the period, transmitting a second signal to cause the key fob to cease to vibrate.

4. A method as claimed in claim 2, further comprising, prior to transmitting the signal to the key fob, determining whether the key fob is located within the vehicle, and in the event that the key fob is determined to be within the vehicle not transmitting the signal to cause the key fob to vibrate.

5. A method as claimed in claim 1, further comprising, if the engine is determined to have been started using the remote start procedure, resetting the timer once before expiry of the period in the event that it is determined that a door has been opened and the transmission has not been engaged.

6. A method as claimed in claim 1, further comprising, if the engine is determined not to have been started using the remote start procedure, subsequent to performing the check to establish whether the driver compartment has any occupants, determining whether a door of the driver compartment has been opened or closed after the determining that the engine is running, and if a door is determined to have been opened or closed, resetting the period of the timer.

7. A method as claimed in claim 1, further comprising determining whether, prior to expiry of the period, any instruction signal has been received by the vehicle from a wireless remote control of the vehicle, and if any such instruction signal is determined to have been received by the vehicle, resetting the timer.

8. A method as claimed in claim 1, further comprising activating a counter on resetting the timer, and incrementing the counter every time that the timer is reset.

9. A control system for an internal combustion engine of a motor vehicle having a driver compartment,
the control system comprising:
an occupant detection module coupled to one or more occupant detection sensors configured to detect the presence of one or more occupants in a driver compartment of the vehicle;
an engine management module coupled to one or more engine status sensors configured to determine whether the engine is running;
one or more door status sensors configured to determine whether a door of the driver compartment is in an open condition or in a closed condition;
the control system being configured, on the engine management module determining that the engine is running, to determine whether or not the engine was started using a remote start procedure;
if the engine is determined to have been started using the remote start procedure, to start a timer to run for a predetermined period;
to determine whether a door of the driver compartment has been opened or closed after the determining that the engine is running; if it is determined that a door has been opened, to determine whether a transmission of the vehicle has been engaged;
if the transmission has not been engaged, to turn off the engine on expiry of the period;
if the engine is determined not to have been started using the remote start procedure, to perform a check to establish whether the driver compartment of the vehicle has any occupants;
to start a timer to run for a predetermined period if the check reveals that there are no occupants in the driver compartment of the vehicle;
to reset the timer in the event that an occupant is detected in the driver compartment of the vehicle before expiry of the period, otherwise to turn off the engine on expiry of the period.

10. A control system as claimed in claim 9, wherein the control system is further configured, in the event that the timer is started following a determination that the engine was not started using the remote start procedure, to transmit a signal to cause a key fob of the vehicle to vibrate.

11. A control system as claimed in claim 10, wherein the control system is further configured, on turning off the engine on expiry of the period, to transmit a second signal to cause the key fob to cease to vibrate.

12. A control system as claimed in claim 10, wherein the control system is further configured to determine, prior to transmitting the signal to the key fob, whether the key fob is located within the vehicle, and in the event that the key fob is determined to be within the vehicle the control system is configured not to transmit the signal to cause the key fob to vibrate.

13. A control system as claimed in claim 9, wherein the control system is further configured, in the event that the engine is determined to have been started using the remote start procedure, to reset the timer once before expiry of the period in the event that it is determined that a door has been opened and the transmission has not been engaged.

14. A control system as claimed in claim 9, wherein the control system is further configured, in the event that the engine is determined not to have been started using the remote start procedure, subsequent to performing the check to establish whether the driver compartment has any occupants, to determine whether a door of the driver compartment has been opened or closed after the determining that the engine is running, and if a door is determined to have been opened or closed, to reset the period of the timer.

15. A motor vehicle having an internal combustion engine and a driver compartment, the motor vehicle comprising:
a controller to operate a control system for the internal combustion engine;
one or more occupant detection sensors coupled to the controller and configured to detect the presence of one or more occupants in the driver compartment of the vehicle;
one or more engine status sensors coupled to the controller and configured to determine whether the engine is running;
one or more door status sensors configured to determine whether a door of the driver compartment is in an open condition or in a closed condition;
the control system being configured, on the one or more engine status sensors determining that the engine is running,
to determine whether or not the engine was started using a remote start procedure;
if the engine is determined to have been started using the remote start procedure, to start a timer to run for a predetermined period;
to use the one or more door status sensors to determine whether a door of the driver compartment has been opened or closed after the determining that the engine is running; if it is determined that a door has been opened, to determine whether a transmission of the vehicle has been engaged;
if the transmission has not been engaged, to turn off the engine on expiry of the period;
if the engine is determined not to have been started using the remote start procedure, to use the one or more occupant detection sensors to perform a check to establish whether the driver compartment of the vehicle has any occupants;
to start a timer to run for a predetermined period if the check reveals that there are no occupants in the driver compartment of the vehicle;
to reset the timer in the event that an occupant is detected in the driver compartment of the vehicle before expiry of the period, otherwise to turn off the engine on expiry of the period.
